(19) United States
(12) Patent Application Publication
(10) Pub. No.: US 2005/0206924 A1
(43) Pub. Date: Sep. 22, 2005

(54) Printer driving method for supporting asymmetric graphic resolution

(76) Inventor: Albert Lin, Taipei City (TW)

Correspondence Address: RABIN & BERDO, P.C., Suite 500, 1101 14 Street, N.W., Washington, DC, 20005, US

(21) Appl. No.: 11/040,295

(22) Filed: Jan. 21, 2005

(30) Foreign Application Priority Data
Mar. 19, 2004 (TW) 93107569

(51) Int. Cl. G06K 15/00

(52) U.S. Cl. 358/1.9; 358/2.1

(57) ABSTRACT

A printer driving method for supporting asymmetric graphic resolution first calls a GUI command based on a symmetric graphic resolution structure, deciphers a conversion command to the symmetric graphic resolution to generate 24-bit RGB data, converts the 24-bit RGB data into 32-bit CMYK data, half-tone processes the 32-bit CMYK data, converts CMYK tones into a plurality of one-bit scan lines, and scales each of the one-bit scan lines along the horizontal and vertical directions for the CMYK colors, respectively, in order to generate an asymmetric graphic printing.

### BACKGROUND OF THE INVENTION

1. Field of the Invention

The present invention relates to a printer driving method for supporting asymmetric graphic resolution, and especially relates to a printer driver for supporting asymmetric graphic resolution.

2. Description of Related Art

The advance of computer technology makes computers omnipresent and computer-related products such as printers are also rapidly progressing. The printers can be classified, according to their operating principles, as dot-matrix, ink-jet and laser printers.

The conventional printer driver generally supports symmetric graphic resolution, such as 300×300 dpi or 600×600 dpi etc. A high-end printer is developed to support asymmetric graphic resolution such as 1200×600 dpi or 2400×1200 dpi; this asymmetric graphic resolution is more common for ink-jet printers.

In prior art method for supporting asymmetric graphic resolution, graphic data was rendering by graphics device interface (GDI) because we fill asymmetric resolution in GDIINFO structure. The graphic data, such as font object, graph object, image object, etc. as well as coordinate system were given by GDI in each DDI function call. However, the printing result for certain application programs (AP) may be erroneous with this approach. When printing graphics with asymmetric graphic resolution, the GDI may send erroneous graphic coordinates or erroneous fonts to the printer driver. The printer suffers from printing errors such as wrong ratio and wrong location. The operating system such as Windows 9x/2k/XP/NT will send the printing graphic to the printer driver by a GDI in order to provide a “what you see, what you print” feature. In the conventional approach, the asymmetric graphic resolution instruction is directly sent to the GDI and then the GDI passes the asymmetric graphic resolution instruction to the printer driver.

However, certain application programs may suffer errors when the asymmetric graphic resolution instruction is sent, from the GDI, to the printer driver. The printer may have printing error such as wrong ratio and wrong location.

Moreover, certain application programs may not support asymmetric graphic resolution. As a result, the user may find erroneous printed results while the graphic to be printed has normal preview on screen.

### SUMMARY OF THE INVENTION

It is the object of the present invention to provide a printer driving method for supporting asymmetric graphic resolution.

To achieve this object, the printer driving method for supporting asymmetric graphic resolution first fill symmetric resolution in GDIINFO structure, GDI will render and pass symmetric data in each DDI function call for driver rendering, consequently printer driver will generate 24-bit RGB data, then by way of CMM(Color matching management) converts 24-bit RGB data to 32-bit CMYK data, then by way of halftoning processes converts 32-bit CMYK data (4 planes, 8 bits) to CMYK 4 bits data (4 planes, 1 bit), and scales each of the one bit scan lines along the horizontal and vertical directions for the CMYK color plane, respectively, in order to generate an asymmetric graphic printing.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIGS. 1A and 1B are schematic views showing conversion of the asymmetric graphic according to the present invention; and

FIG. 2 shows a flowchart of a printer driving method for supporting asymmetric graphic resolution according to the present invention.

### DETAILED DESCRIPTION OF PREFERRED EMBODIMENTS

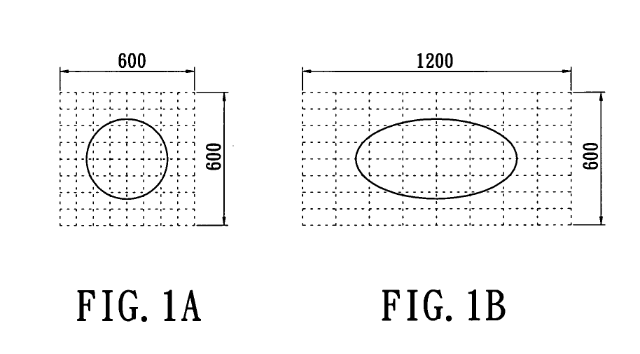

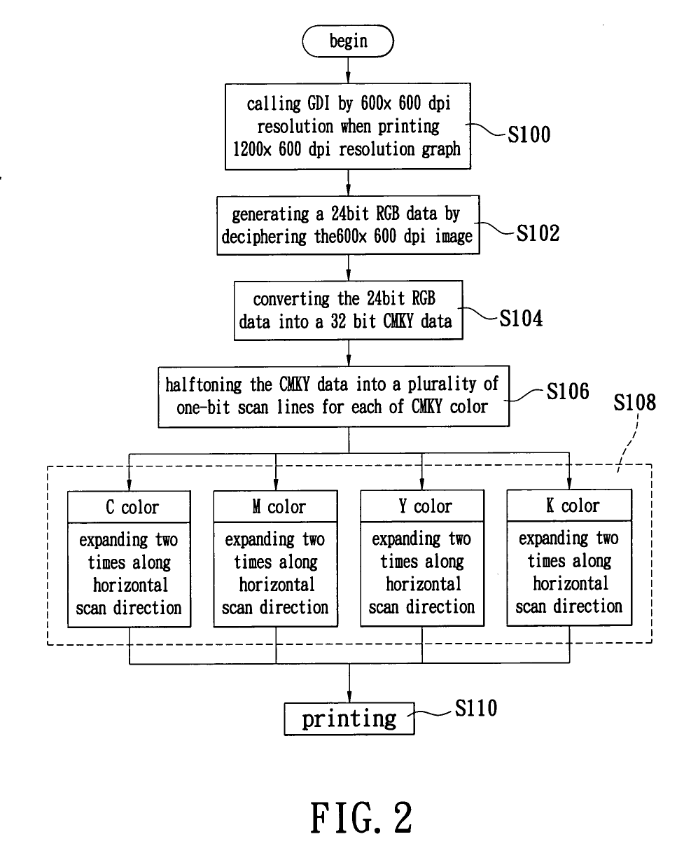

FIGS. 1A and 1B are schematic views showing conversion of the asymmetric graphic according to the present invention. FIG. 2 shows a flowchart of a printer driving method for supporting asymmetric graphic resolution according to the present invention. The asymmetric graphic resolution includes the conditions of symmetric graphic resolution (x,y), z-multiple resolution along horizontal direction (zx, y) and z-multiple resolution along vertical direction (x, zy). The present invention is exemplified with 1200×600 dpi asymmetric graphic resolution.

FIG. 1B shows a schematic view of a 600×600 dpi graph and FIG. 1A shows a schematic view of a 1200×600 dpi graph, which has 2-times resolution along horizontal direction compared with the graph in FIG. 1B. In the present invention, the graphic device interface (GDI) instruction is first invoked with 600×600 dpi symmetric graphic resolution to describe the symmetric graphic (x, y). The image is sent to the printer through the graphic device interface (GDI) to provide “what you see, what you print” output.

Afterward, in step S102, a raster image processing (RIP) is used to decipher the 600×600 dpi symmetric graphic into 24 bit RGB data.

Afterward, in step S104, a color management module (CMM) is used to convert the 24 bit RGB data into 32 bit CMYK (cyan, magenta, yellow and black) data. The CMYK data are essential elements for color printing.

Afterward, in step S106, a halftoning process is performed, by a halftoning system, to convert the 32 bit CMYK data into a plurality of scan lines of 1 bit data for printer.

Afterward, in step S108, each of the plurality of scan lines corresponding to the CMYK data is expanded two-fold in the horizontal direction (x direction). The original 600×600 dpi symmetric graphic is converted into a new 1200×600 dpi graph in step S110.

Similarly, the image of 600×1200 dpi asymmetric graphic resolution is a two-fold expansion in the vertical direction for a 600×600 dpi symmetric graphic. According to the method of the present invention, each of the plurality of scan lines corresponding to the CMYK data is extended two-fold in the vertical direction (y direction).

The conventional method for printing asymmetric graphic expands the 24 bit RGB data in the horizontal or vertical direction during the raster image processing (RIP). On the contrary, the inventive method for printing asymmetric graphic expands the 32 bit CMYK data in the horizontal or vertical direction after halftoning treatment. The processing complexity of conventional method is 6 times of that of the method according to the present invention. Therefore, the data processing efficiency of the method according to the present invention is 5 times in comparison with the conventional method.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A printer driving method for supporting asymmetric graphic resolution, the asymmetric graphic resolution being a z-times expansion along a horizontal direction or vertical direction from a symmetric graphic resolution, the method comprising the steps of:
interpreting a structure of the symmetric graphic resolution by calling a graphic device interface (GDI) instruction;
generating RGB data of multiple bits by deciphering the symmetric graphic resolution (x, y);
converting the RGB data of multiple bits into CMYK data of multiple bits;
halftoning the CMYK data into a plurality of one-bit scan lines for each of CMYK color in the CMYK data;
expanding or shrinking each of the one-bit scan lines for each CMYK color in the CMYK data along the horizontal or vertical direction by z times, thus printing an image of asymmetric graphic resolution (zx, y) or (x, zy).

2. The printer driving method for supporting asymmetric graphic resolution as in claim 1, wherein the step of deciphering the symmetric graphic resolution (x, y) is performed by raster image processing (RIP).

3. The printer driving method for supporting asymmetric graphic resolution as in claim 1, wherein the step of deciphering the symmetric graphic resolution (x, y) generates 24-bit RGB data.

4. The printer driving method for supporting asymmetric graphic resolution as in claim 1, wherein the step of converting the RGB data into CMYK data is performed by a color management module (CMM).

5. The printer driving method for supporting asymmetric graphic resolution as in claim 1, wherein the step of converting the RGB data into CMYK data generates 32-bit CMYK data.

6. The printer driving method for supporting asymmetric graphic resolution as in claim 1, wherein the step of halftoning the CMYK data is performed by a halftoning module to convert the CMYK data into a plurality of one-bit scan lines for each CMYK color in the CMYK data.
